(19) United States
(12) Patent Application Publication
(10) Pub. No.: US 2002/0118561 A1
(43) Pub. Date: Aug. 29, 2002

(54) Power conversion adapter

(76) Inventors: Takayuki Katayama, Fukuoka (JP); Nobuki Itou, Fukuoka (JP)

Correspondence Address: WHITHAM, CURTIS & CHRISTOFFERSON, P.C., SUITE 340, 11491 SUNSET HILLS ROAD, P.O. BOX 9204, RESTON, VA, 20190, US

(21) Appl. No.: 10/082,200

(22) Filed: Feb. 26, 2002

(30) Foreign Application Priority Data
Feb. 27, 2001 (JP) P.2001-53059

(51) Int. Cl. H02M 1/00

(52) U.S. Cl. 363/146

(57) ABSTRACT

In a power conversion adapter which is connected to an AC power supply receptacle to convert AC power supplied therefrom to DC power, a casing body has a first principal face, a second principal face which extend in parallel with each other, and at least one pair of connection passages extending from the first principal face to the second principal face. Conductive members are disposed within the casing body so as to elastically protrude into the respective connection passages while being electrically connected to an AC/DC converter. At least one plug member each includes a base portion, and a pair of plug pieces extended from the base portion so as to have a length which is longer than a length of the connection passages. The plug member is detachably combined with one of the first principal face and the second principal face of the casing body such that the plug pieces are inserted into the connection passages while being electrically connected with the conductive members. A portion of each plug piece protruded from the other one of the first principal face and the second principal face is inserted into each plug fitting hole of the AC power supply receptacle.

### BACKGROUND OF THE INVENTION

The present invention relates to a power conversion adapter (hereunder referred to as an AC adapter) connected to an AC power supply and adapted to perform power conversion by a built-in alternating current-direct current (AC-DC) conversion circuit and to output DC power to equipment connected thereto.

AC adapters are used, for example, in the case of using a charger, which charges a rechargeable battery, and electronic equipment, which employs a DC power source as a power supply, by connecting the charger and the electronic equipment to a commercial power supply. Further, AC adapters convert DC to AC and supply AC to equipment connected thereto. As shown in FIG. 7, a first related AC adapter 50 is constructed so that a circuit board (not shown), on which a power transformer (not shown) and components of a power supply circuit (not shown) are mounted, is built in a casing 51, that a pair of plug pieces 52a, 52b to be respectively plugged into plug holes 61a and 61b of a power supply receptacle 60 is provided on one of side faces of the casing 51 in such a way as to protrude therefrom, and that a connection code 53 to be connected to equipment (not shown) is drawn out of the casing 51.

As portable telephones, various kinds of mobile equipment, and notebook personal computers come into wide use, it has been often that a user carries an AC adapter so as to charge a rechargeable battery, which is used as a power supply therefor, at a place away from home. As described above, a power transformer, which is relatively large in weight and size, is built in the first related AC adapter 50. Therefore, the first related AC adapter 50 has a drawback in that this related AC adapter is large in size and weight, and that it is difficult to carry this related AC adapter as a portable one. Moreover, the AC adapter 50 has another drawback in that the plug pieces 52a, 52b are bent or damaged when carelessly dropped while carried.

Meanwhile, the reduction in size and weight of the AC adapter 50 can be achieved by, for example, employing thin film devices as various components of the AC-DC conversion circuit. However, as described above, the plug pieces 52a, 52b are provided in such a way as to be orthogonal to the side face of the casing 51 and as to project therefrom, so that the thickness of the entire AC adapter 50 cannot be reduced. Therefore, regarding AC adapters, for instance, a second related AC adapter 55, in which each of the base portions of the plug pieces 52a, 52b is supported by a rotating mechanism as shown in FIG. 8, and a third related AC adapter 57, in which the plug pieces 52a, 52b freely go in and out of the casing 51 as illustrated in FIG. 9, have been provided.

The second related AC adapter 55 is constructed so that when unused, the plug pieces 52a, 52b are accommodated in slits 56 formed in the casing 51, as represented by arrows in FIG. 8. Conversely, when used, the plug pieces 52a, 52b are plugged into plug holes 61 of the power supply receptacle 60 by being rotated and operated in such a manner as to be orthogonal to the casing 51, as represented by solid lines in this figure. Thus, the AC adapter 55 can be carried by accommodating, when unused, the plug pieces 52a, 52b in the casing 51 so that the plug pieces 52a, 52b are not hindrances to carrying the AC adapter 55.

On the other hand, the third related AC adapter 57 is constructed so that when unused, the plug pieces 52a, 52b are respectively accommodated in mounting holes formed in the casing 51, as represented by arrows in FIG. 9, and that when used, the plug pieces 52a, 52b are drawn out of the casing 51 and plugged into plug holes 61 of the power supply receptacle 60, as represented by solid lines in this figure. With such a configuration, the adapter 57 can be carried so that the plug pieces 52a, 52b are not hindrances to carrying the AC adapter 57.

However, the second related AC adapter 55 has a drawback in that because a bearing mechanism for rotating and supporting the plug pieces 52a, 52b, and a contact mechanism for connecting these plug pieces 52a, 52b to the circuit board, or a lock mechanism for holding the plug pieces 52a, 52b in a rotating position are provided therein, the number of components thereof is large, and the structure thereof is complex.

Further, the AC adapter 55 has a drawback in that because the slits 56, in which the plug pieces 52a, 52b are respectively accommodated, are formed in the casing 51, a dead space is produced in the casing 51, so that it is difficult to considerably reduce the size thereof. Furthermore, the AC adapter 55 has another drawback in that because the plug pieces 52a, 52b are formed from metal pieces each having a certain amount of thickness, the width of each of the slits 56 increases, so that the size of the casing 51 increases.

On the other hand, the third related AC adapter 57 requires a lock mechanism for holding the plug pieces in an accommodated state or in a drawn-out state. Thus, the AC adapter 57 has drawbacks in that the number of components thereof is large, and that the structure thereof is complex.

Moreover, in the AC adapter 57, a supporting portion for the plug pieces 52a, 52b is unstable. Moreover, the AC adapter 57 has another drawback in that the size thereof becomes larger when a supporting mechanism having large mechanical strength is constructed to thereby securely support the plug pieces 52a, 52b. Furthermore, the AC adapter 57 is constructed so that the casing 51 has a width sufficient to accommodate the plug pieces 52a, 52b. Thus, the AC adapter 57 has another drawback in that there is a restriction on reduction in the entire size of the AC adapter 57.

### SUMMARY OF THE INVENTION

It is therefore an object of the invention to provide a power conversion adapter that has a simple structure and that is enabled to significantly enhance the portability thereof by reduction in the weight and size thereof.

In order to achieve the above object, according to the present invention, there is provided A power conversion adapter which is connected to an AC power supply receptacle to convert AC power supplied therefrom to DC power, comprising:

a casing body having a first principal face and a second principal face which extend in parallel with each other, the casing body formed with at least one pair of connection passages extending from the first principal face to the second principal face;

an AC/DC converter, deposed within the casing body;

conductive members, disposed within the casing body so as to elastically protrude into the respective connection passages while being electrically connected to the AC/DC converter; and

at least one plug member, each including:

a base portion; and

a pair of plug pieces extended from the base portion so as to have a length which is longer than a length of the connection passages, wherein:

the plug member is detachably combined with one of the first principal face and the second principal face of the casing body such that the plug pieces are inserted into the connection passages while being electrically connected with the conductive members; and

a portion of each plug piece protruded from the other one of the first principal face and the second principal face is inserted into each plug fitting hole of the AC power supply receptacle.

In this configuration, the casing body and the plug member are provided as individual members so that the plug pieces of the plug member are fitted into the connection passages of the casing body only when the adapter is connected to the power supply receptacle. Consequently, the plug pieces do not protrude from the casing body when the adapter is not used. Thus, the adapter can be treated by reducing the entire size and thickness of the adapter. Moreover, since the plug pieces are not hindrances to carrying the adapter, the portability thereof is significantly enhanced. Furthermore, since there is no necessity for a mechanism for rotating and supporting the plug pieces or for sliding and supporting the plug pieces, the structure thereof can be simplified. Therefore, the size, weight, thickness and cost thereof can be totally reduced.

Preferably, the casing body has side end faces defining a distance between the first principal face and the second principal face as a thickness of the casing body. The thickness is substantially identical with a distance between the pair of plug pieces.

Here, it is preferable that the plug member is attached on one of the side end faces of the casing body so that one side end portion of the casing body enters into a space defined by the pair of plug pieces, when the plug member is not connected to the AC power supply receptacle.

Preferably, the power conversion adapter further comprises a chain member which connects the casing body and the plug member.

Preferably, the base portion is provided as an elastic flat plate member from which the plug pieces are extended in opposite directions. The base portion is flexed such that the plug pieces extend in parallel with each other when the plug pieces are inserted into the connection passages.

Here, it is preferable that a holder is formed on the casing body to hold the plug member thereon when the plug member is not connected to the AC power supply receptacle.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is an exploded perspective view illustrating an AC adapter according to a first embodiment of the invention;

FIG. 2 is an enlarged vertical section view illustrating a state in which the AC adapter is connected to a power supply receptacle;

FIG. 3 is an enlarged horizontal section view illustrating a state in which the AC adapter is connected to the power supply receptacle;

FIG. 4 is an exploded perspective view illustrating an AC adapter according to a second embodiment of the invention;

FIG. 5 is a perspective view illustrating a plug member used in the AC adapter of the second embodiment;

FIG. 6 is a perspective view illustrating a state in which the plug member is combined with an adapter body of the AC adapter of the second embodiment;

FIG. 7 is a perspective view illustrating a first related AC adapter;

FIG. 8 is a perspective view illustrating a second related AC adapter; and

FIG. 9 is a perspective view illustrating a third related AC adapter.

### DETAILED DESCRIPTION OF THE PREFERRED EMBODIMENTS

Hereinafter, preferred embodiments of the invention will be described in detail with reference to the accompanying drawings.

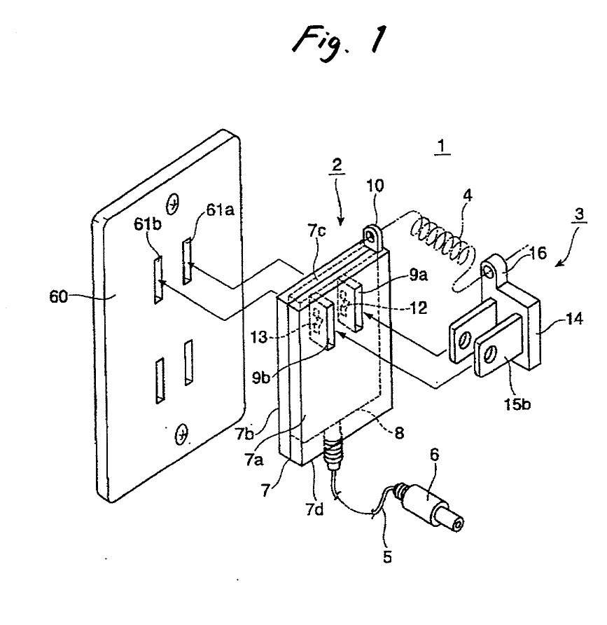

As illustrated in FIGS. 1 to 3, an AC adapter 1 according to a first embodiment comprises an adapter body 2 and a plug member 3, which are provided as individual members. The plug member 3 is connected to the adapter body 2 by a connection chain 4 so that the plug member 3 is prevented from being lost. As shown in FIG. 1, in the AC adapter 1, a connection code 5 is drawn out of the adapter body 2. DC power is obtained by performing power conversion on commercial power and supplied by connecting a plug 6 provided at an end of this connection code 5 to a charger for charging a rechargeable battery or to electronic equipment that requires a DC power supply.

The adapter body 2 has a casing 7 that is obtained by assembling a pair of halves formed like rectangular shallow pans from an insulating synthetic resin material and that is presented like a thin housing as a whole. A circuit board 8 provided with an AC-DC conversion circuit, the description of details of which is omitted, is provided, is built in this casing 7. In the adapter body 2, appropriate electronic components of an AC-DC conversion circuit are mounted on the circuit board 8. Moreover, coil elements and various thin film devices of a power transformer are formed on the circuit board 8 by utilizing thin film formation techniques. A pair of plug fitting holes 9a and 9b are formed in the adapter body 2 in such a way as to penetrate through the front and rear principal faces 7a and 7b of the casing 7. A connection convex 10 for connecting an end portion of a connection chain 4 to one side face (top face) 7c in the longitudinal direction of the casing 7 is provided on the adapter body 2 in such a manner as to be integral therewith and to protrude therefrom.

Incidentally, a drawing hole is formed in the other side face (bottom face) in the longitudinal direction of the casing 7 of the adapter body 2. The aforementioned connection code 5 is drawn therefrom by inserting a bush into this drawing hole so as to prevent the slip-off thereof and as to protect the cord 5. The connection code 5 is connected to an output terminal portion, which is formed on the circuit board 8, at an end portion thereof drawn in to the casing 7. The connection code 5 may be connected to the adapter body 2 by, for example, connecting a coaxial plug to an end thereof and inserting the coaxial plug into a jack attached to the casing 7.

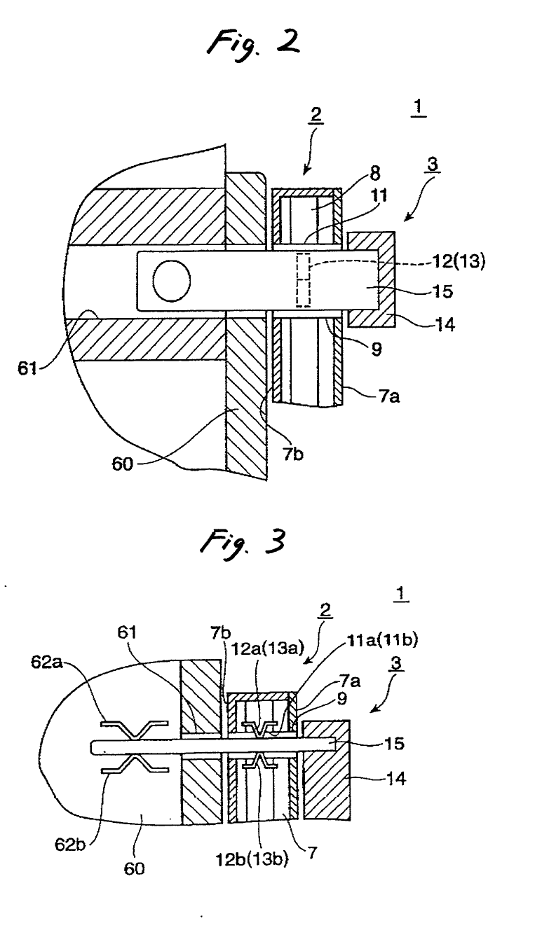

The plug fitting holes 9a and 9b are formed in the casing 7 so that the distance therebetween and the opening size thereof are equal to the distance between the plug holes 61a and 61b and to the opening size of each of the holes 61a and 61b, respectively. As illustrated in FIGS. 2 and 3, guide holes 11a and 11b, which are formed in the circuit board 8 built in the casing 7 in such a way as to penetrate therethrough, communicate with each other. Each of the guide holes 11a and 11b is formed in the casing 8 so that the distance therebetween and the opening size thereof are equal to the distance between the plug fitting holes 9a and 9b and to the opening size of each of the holes 9a and 9b, respectively.

A pair of electrode pieces 12a and 12b are attached to the circuit board 8 in such a way as to be placed across the guide hole 11a, while a pair of electrode pieces 13a and 13b are attached to the circuit board 8 in such a way as to be placed across the guide hole 11b. Each of the pairs of the electrode pieces 12a and 12b and the electrode pieces 13a and 13b is integrally formed from a resilient metal plate member. Although the description of the details of the structure of the electrode piece is omitted, each of the electrode pieces has a base portion, which is fixed onto the primary face of the circuit board 8 along an opening edge of a corresponding one of the guide holes 11a and 11b, and a contact piece portion that is formed in parallel with the guide holes 11a and 11b in such a way as to rise from this base portion.

The contact piece portions of the electrode pieces 12a, 12b or 13a, 13b of each of the pairs face each other across a corresponding one of the guide holes 11a and 11b. Moreover, as shown in FIG. 3, the contact piece portions of the electrode pieces of each of the pairs are bent so that the central parts thereof abut against each other. Therefore, the contact piece portions of the electrode pieces 12a, 12b or 13a, 13b of each of the pairs are made to extend along both sides of the corresponding one of the guide holes 11a, 11b, in other words, the plug fitting holes 9a and 9b, and to protrude therefrom.

Incidentally, each of the electrode pieces may be constituted by, for instance, a metal ball and a spring for urging this metal ball so as to protrude into the plug fitting hole 9. Further, the adapter body 2 may be constructed so that each of the electrode pieces 12 and 13 is attached to a predetermined portion, which is suitably formed in such a way as to be integral with the casing 7, and connected to the terminal portion of the circuit board 8 by a lead wire.

The plug member 3 comprises a plate-shaped base portion 14, the entirety of which is formed from an insulating synthetic resin, and a pair of plug pieces 15a and 15b insert-molded into this base portion 14. The plug member 3 has a connection convex 16 formed on the top part of the base portion 14 in such a manner as to be integral therewith, and the other end of the aforementioned connection chain 4 is connected to the connection convex 16. It is sufficient for the base portion 14 to maintain the distance between the opposed plug pieces 15a and 15b and to support base end portions thereof. Thus, the base portion 14 does not require high mechanical strength. Consequently, the base portion 14 is formed in such a way as to be relatively thin.

The plug pieces 15a and 15b are orthogonal to the primary face of this base portion 14 and placed in such a way as to be parallel to and to face each other. The distance between the plug pieces 15a and 15b is set to be equal to that between the plug holes 61a and 61b of the power supply receptacle 60. The size of a section of each of the plug pieces 15a and 15b is nearly equal to the opening size of each of the plug holes 61a and 61b. In other words, the distance between the plug pieces 15a and 15b and the size of the section of each of the plug pieces 15a and 15b are nearly equal to the distance between the plug fitting pieces 9a and 9b and the size of the section of each of the plug pieces 15a and 15b. Moreover, each of the plug pieces 15a and 15b has a length that is sufficiently longer than the thickness of the casing 7 of the adapter body 2.

In the plug member 3 constructed as described above, the plug pieces 15a and 15b are fitted into the plug fitting holes 9a and 9b of the adapter body 2, respectively. In the plug member 3, the plug pieces 15a and 15b are respectively fitted into the plug fitting holes 9a and 9b from either of the front and rear primary faces 7a and 7b of the casing 7. The plug member 3 is adapted so that, for example, when the plug pieces 15a and 15b are respectively fitted into the plug fitting holes 9a and 9b from one of the primary faces 7a, the end portions of the plug pieces 15a and 15b protrude from the other primary face 7b of the casing 7.

The plug member 3 is constructed so that the plug pieces 15a and 15b fitted into the plug fitting holes 9a and 9b penetrate through the adapter body 2 during push-opening the pair of electrode pieces 12a and 12b and the pair of the electrode pieces 13a and 13b, as illustrated in FIG. 3. Thus, in the plug member 3, the plug piece 15a is electrically conducted to the electrode pieces 12a and 12b, while the plug piece 15b is electrically conducted to the electrode pieces 13a and 13b. Consequently, the plug member 3 is connected to the AC-DC conversion circuit provided on the circuit board 8 that is built in the adapter body 2.

As described the above, the base portion 14 is formed in such a way as to be thin, has a certain degree of elasticity so as to be deformable. Therefore, when the AC adapter 1 is unused, the plug pieces 15a and 15b are pulled out of the plug fitting holes 9a and 9b, and the plug member 3 is placed on one side portion of the casing 7 such that the side portion is entered into a space between the plug pieces 15a and 15b. This makes the AC adapter 1 portable. Since the adapter body 2 and the plug member 3 are provided as individual members, appropriate position at which the plug member 3 is placed can be selected.

After combining the adapter body 2 and the plug member 3 such that the end portions of the plug pieces 15a and 15b are protruded and exposed from the primary face 7b of the casing 7 as described the above, the AC adapter 1 is fitted into the plug holes 61a and 61b of the power supply receptacle 60. The plug pieces 15a and 15b are sandwiched by the electrode spring members 62a and 62b of the power supply receptacle 60 so that AC power is supplied from the power supply receptacle 60 through the electrode spring members 62a and 62b to the AC adapter 1.

In the AC adapter 1, the AC power is supplied to the AC-DC conversion circuit through the plug pieces 15a and 15b so that an AC voltage is converted into a predetermined DC voltage. The AC adapter 1 outputs a DC current, which is obtained by the conversion, from the connection code 5, and supplied the outputted DC current to equipment connected thereto.

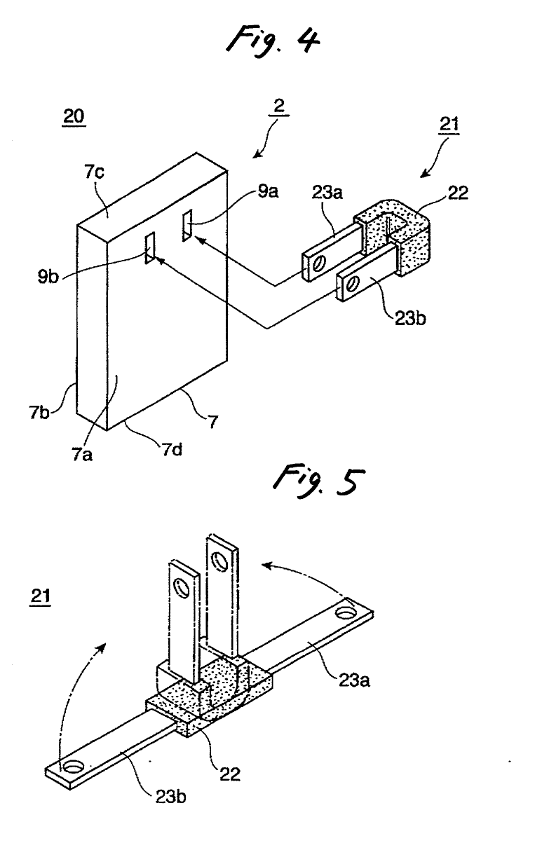

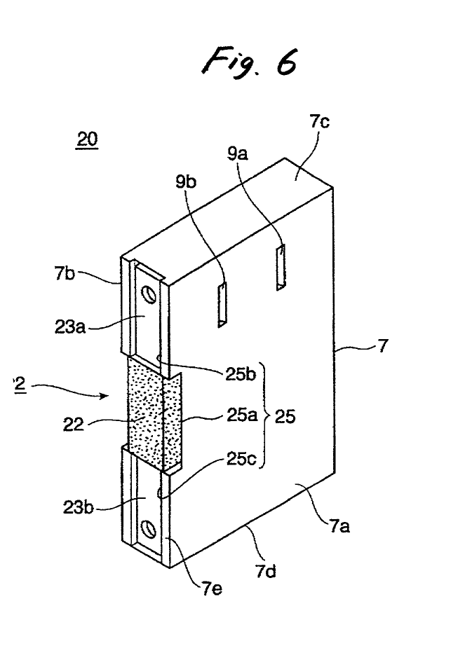

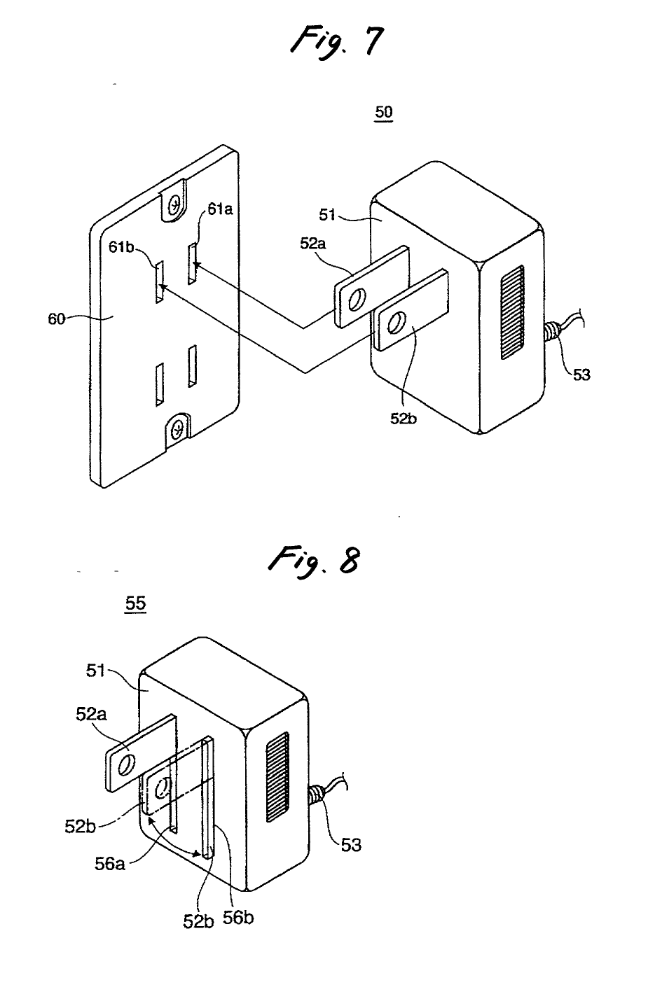

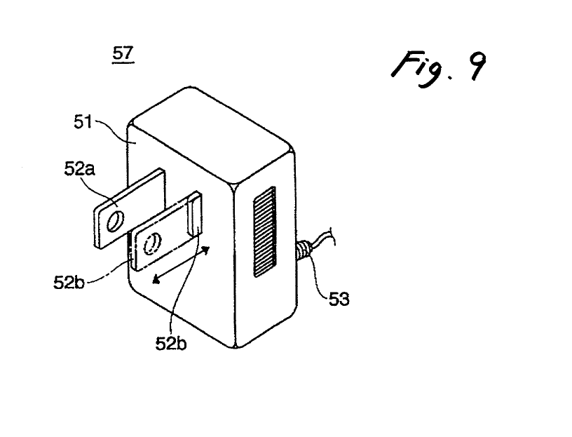

An AC adapter 20 according to a second embodiment of the invention is illustrated in FIGS. 4 and 5. In this embodiment, there is provided a configuration having a plug member 21 that enables further reduction in the size of the AC adapter. The AC adapter 20 employs the adapter body 2 of the aforementioned AC adapter 1. Thus, the detail description of the adapter body of the AC adapter 20 is omitted herein. A plug member 21 of the AC adapter 20 has a basic configuration, which has a connecting base portion 22 formed from an insulating synthetic resin material and a pair of plug pieces 23a and 23b insert-molded into this connection base portion 22, and which is similar to that of the plug member 3.

In the plug member 21, the connection base portion 22 is shaped like a thin rectangle having a length that is slightly longer than the distance between the plug fitting holes 9a and 9b of the adapter body 2. The connection base portion 22 has flexibility in the direction of thickness thereof. Plug pieces 23a and 23b are integrally insert-molded into the connection base portion 22 at both sides in the longitudinal direction thereof. As indicated by solid lines in FIG. 5, when unused, in the plug member 21, the plug pieces 23a and 23b are aligned in a line through the connection base portion 22, so that the entire plug member 21 is presented like a single plate.

The plug pieces 23a and 23b are formed so that the size of a section of each of the plug pieces 23a and 23b is nearly equal to the opening size of each of the plug holes 61a and 61b. In other words, each of the plug pieces 23a and 23b is formed so that the distance therebetween and the size of the section thereof are nearly equal to the distance between and the opening size of the plug fitting holes 9a and 9b of the adapter body 2, respectively. Each of the pieces 23a and 23b has a length that is sufficiently longer than the thickness of the casing 7 of the adapter body 2. The insulation between the plug pieces 23a and 23b is held by the connection base portion 22. Therefore, in the AC adapter 20, the plug pieces 23a and 23b of the plug member 21 do not project therefrom, so that these plug pieces do not hinder the AC adapter 20 from being carried. Consequently, not only the downsizing of the AC adapter 20 is achieved, but also the portability thereof is enhanced.

The plug member 21 is adapted so that when the AC adapter 20 is used, the connection base portion 22 is bent so as to be U-shaped, as indicated by chain lines in FIG. 5. When the plug member 21 is in such a condition that the plug pieces 23a and 23b are caused to face each other, the plug pieces 23a, 23a are fitted into the plug fitting holes 9a, 9a of the adapter body 2, as indicated by an arrow in FIG. 4. When the plug pieces 23a, 23a of the plug member 21 are respectively fitted into the plug fitting holes 9a, 9b from the one of the primary faces 7a of the casing 7 of the adapter body 2, the end portions thereof project from the other primary face 7b of the casing 7.

In the plug member 21, each of the plug pieces 23a, 23b fitted into the plug fitting holes 9a, 9b is electrically conducted to a corresponding one of pairs of electrode pieces 12a, 12b and electrode pieces 13a, 13b, which are projected into the guide holes 11a and 11b of the circuit board 8. Thus, the plug member 21 is connected to the AC-DC conversion circuit provided on the circuit board 8 built in the adapter body 2.

After the plug member 21 is combined with the adapter body 2 as described above, the end portions of the plug pieces 23a, 23a of the plug member 21, which are projected and exposed from the other primary face 7b of the casing 7 of the adapter body 2, are fitted into the plug holes 61a, 61b of the power supply receptacle 60. In the AC adapter 20, the plug pieces 23a, 23b are sandwiched by the electrode spring members 62a, 62a of the power supply receptacle 60 so that AC power is supplied from the power supply receptacle 60 to the AC-DC conversion circuit of the adapter body 2 of the AC adapter 20 through the electrode spring members 62a, 62b and the plug pieces 23a, 23b.

In the AC-DC conversion circuit of the AC adapter 20, the AC power is converted so that an AC voltage is converted into a predetermined DC voltage. The AC adapter 20 outputs a DC current, which is obtained by the conversion, from the connection code 5, and supplied the outputted DC current to equipment connected thereto.

Since the plug member 21 becomes a single plate member in a normal condition, as described above, when the AC adapter 20 is carried or unused, the plug member 21 can be handled by being attached on the thin adapter body 22.

Namely, the aforementioned AC adapter 20 does not employ such a structure in which the plug member is connected to the adapter body by a connection chain, which prevents the plug member from being lost. Therefore, a structure for holding the unused plug member 21 may be formed in the casing 7 of the AC adapter 20, similarly as the adapter body 2 illustrated in, for instance, FIG. 6.

That is, in the adapter body 2, a plug member holder 25 is formed over the entirety of one of the side faces 7e in the longitudinal direction of the casing 7. The plug member holder 25 comprises a base portion holding part 25a of the central portion thereof, and plug piece holding parts 25b, 25c formed at both sides of this base portion holding part 25a in such a way as to communicate with each other. The base portion holding part 25a is shaped like a groove having a size, which is sufficient for fitting the connection base portion 22 of the plug member 21 thereinto. Each of the plug piece holding parts 25b, 25c is formed such that one end thereof is opened to this base portion holding part 25a, and that the other end of each of the plug piece holding parts 25b, 25c is opened to a corresponding one of the top face 7c and the bottom face 7c of the casing 7. Each of the plug piece holding parts 25b, 25c is shaped like a groove having a size, which is sufficient for fitting a corresponding one of the plug pieces 23a, 23b of the plug member 21 thereinto.

As illustrated in FIG. 6, the plug member 21 is assembled to the adapter body 2 by fitting, when the AC adapter 20 is unused, the connection base portion 22 into the base portion holding part 25a and moreover, fitting the plug pieces 23a, 23b into the plug piece holding parts 25b and 25c, respectively. The plug member 21 is formed in such a way as to be integral with the adapter body 2 by causing the groove walls of the plug member holder 25 to hold the connection base portion 22 or the plug pieces 23a, 23b. Therefore, according to the AC adapter 20, the plug member 21 is held by the adapter body 2, so that this plug member 21 is restrained by from being lost, and that the handling of this adapter is facilitated still more.

Incidentally, regarding the adapter body 2, the configuration of the plug member holder 25 is not limited to the aforementioned configuration. An appropriate locking convex adapted to project into the groove so as to more reliably hold the plug member 21 may be formed in such a way as to be integral therewith. Further, regarding the adapter body 2, when the length of the plug member 21 is longer than that of the side face 7e of the casing 7, the plug member holder 25 may be formed in such a way as to extend over other side faces orthogonal to the side face 7e.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A power conversion adapter which is connected to an AC power supply receptacle to convert AC power supplied therefrom to DC power, comprising:
a casing body having a first principal face and a second principal face which extend in parallel with each other, the casing body formed with at least one pair of connection passages extending from the first principal face to the second principal face;
an AC/DC converter, deposed within the casing body;
conductive members, disposed within the casing body so as to elastically protrude into the respective connection passages while being electrically connected to the AC/DC converter; and
at least one plug member, each including:
a base portion; and
a pair of plug pieces extended from the base portion so as to have a length which is longer than a length of the connection passages, wherein:
the plug member is detachably combined with one of the first principal face and the second principal face of the casing body such that the plug pieces are inserted into the connection passages while being electrically connected with the conductive members; and
a portion of each plug piece protruded from the other one of the first principal face and the second principal face is inserted into each plug fitting hole of the AC power supply receptacle.

2. The power conversion adapter as set forth in claim 1, wherein:
the casing body has side end faces defining a distance between the first principal face and the second principal face as a thickness of the casing body; and
the thickness is substantially identical with a distance between the pair of plug pieces.

3. The power conversion adapter as set forth in claim 2, wherein the plug member is attached on one of the side end faces of the casing body so that one side end portion of the casing body enters into a space defined by the pair of plug pieces, when the plug member is not connected to the AC power supply receptacle.

4. The power conversion adapter as set forth in claim 1, further comprising a chain member which connects the casing body and the plug member.

5. The power conversion adapter as set forth in claim 1, wherein:
the base portion is provided as an elastic flat plate member from which the plug pieces are extended in opposite directions; and
the base portion is flexed such that the plug pieces extend in parallel with each other when the plug pieces are inserted into the connection passages.

6. The power conversion adapter as set forth in claim 5, wherein a holder is formed on the casing body to hold the plug member thereon when the plug member is not connected to the AC power supply receptacle.
